(19) United States
(12) Patent Application Publication
(10) Pub. No.: US 2009/0055212 A1
(43) Pub. Date: Feb. 26, 2009

(54) RECORDING MEDIUM IN WHICH DELEGATION MEDIATING PROGRAM IS RECORDED, DELEGATION MEDIATING APPARATUS AND DELEGATION MEDIATING METHOD

(75) Inventors: Nobuyuki IGATA, Kawasaki (JP); Yoshio NAKAO, Kawasaki (JP); Hiroshi YAMAKAWA, Kawasaki (JP); Koji MARUHASHI, Kawasaki (JP); Masahiro ASAOKA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/193,294

(22) Filed: Aug. 18, 2008

(30) Foreign Application Priority Data
Aug. 20, 2007 (JP) 2007-213990

(51) Int. Cl. G06F 17/30; G06Q 99/00

(52) U.S. Cl. 705/1

(57) ABSTRACT

A delegation mediating apparatus which presents a voter who wants to collect delegations to another voter who is looking for a delegatee, in a decision to be made by voting by multiple voters, the apparatus including, voting history storage unit for storing each voter's past voting history in a voting history storage unit, similarity degree calculation unit for calculating a degree of voting action similarity between the voter who wants to collect delegations and the other voter who is looking for a delegatee, with the use of the past voting history stored in the voting history storage unit, and delegatee presentation unit for presenting the voter who wants to collect delegations if the degree of similarity to the other voter who is looking for a delegatee is high, to the other voter who is looking for a delegatee.

### TECHNICAL FIELD

This technique relates to a delegation mediating program, a delegation mediating apparatus and a delegation mediating method for presenting one voter who wants to be a delegatee to another voter who is looking for a delegatee to vote on behalf of the other voter for a decision made by multiple votes.

### SUMMARY

A delegation mediating apparatus mediates between a voter who wants to collect delegations and another voter who is looking for a delegatee, in a decision to be made by voting by multiple voters. The apparatus includes:

voting history storage unit for storing each voter's past voting history in a voting history storage unit;

similarity degree calculation unit for calculating a degree of voting action similarity between the voter who wants to collect delegations and the other voter who is looking for a delegatee, with the use of the past voting history stored in the voting history storage unit; and

delegatee presentation unit for presenting the voter who wants to collect delegations and whose degree of similarity to the other voter who is looking for a delegatee is high, to the other voter who is looking for a delegatee.

### BRIEF DESCRIPTION OF THE DRAWINGS

FIG. 1 is a diagram for illustrating the outline and characteristics of a delegation mediating apparatus according to a first embodiment;

FIG. 2 is a block diagram showing the configuration of the delegation mediating apparatus according to the first embodiment;

FIG. 3 is a diagram showing an example of a management file;

FIG. 4 is a diagram showing an example of a delegation collection information storage data base;

FIG. 5 is a diagram showing an example of a voting history storage database;

FIG. 6 is a diagram showing an example of a related agenda item information storage database;

FIG. 7 is a diagram showing an example of an administrative policy setting screen;

FIG. 8 is a diagram showing an example of a delegation collection information registration screen;

FIG. 9 is a diagram showing an example of applying weights to related agenda items;

FIG. 10 is a diagram showing an example of calculation of a degree of voting action similarity;

FIG. 11 is a diagram showing an example of an output screen displayed when delegation collection information is referred to;

FIG. 12 is a diagram showing an example of creation of a voting action comparison table;

FIG. 13 is a flowchart showing the processing operation of the delegation mediating apparatus according to the first embodiment;

FIG. 14 is a flowchart showing a voting action similarity degree calculation procedure;

FIG. 15 is a flowchart showing a voting action comparison table creation procedure;

FIG. 16 is a flowchart showing a procedure for determining the range of voting history to be used for generation of delegatee certification information; and

FIG. 17 is a diagram showing a computer which executes a delegation mediating program.

### DETAILED DESCRIPTION OF THE EMBODIMENTS

A delegation mediating program, a delegation mediating apparatus and a delegation mediating method according to this technique will be described in detail below with reference to the accompanying drawings.

### First Embodiment

In the embodiment below, the outline and the characteristics of a delegation mediating apparatus according to a first embodiment, and the configuration and the processing flow of the delegation mediating apparatus will be sequentially described, and the advantages of the first embodiment will be described at the end.

### Outline and Characteristics of the Delegation Mediating Apparatus According to the First Embodiment

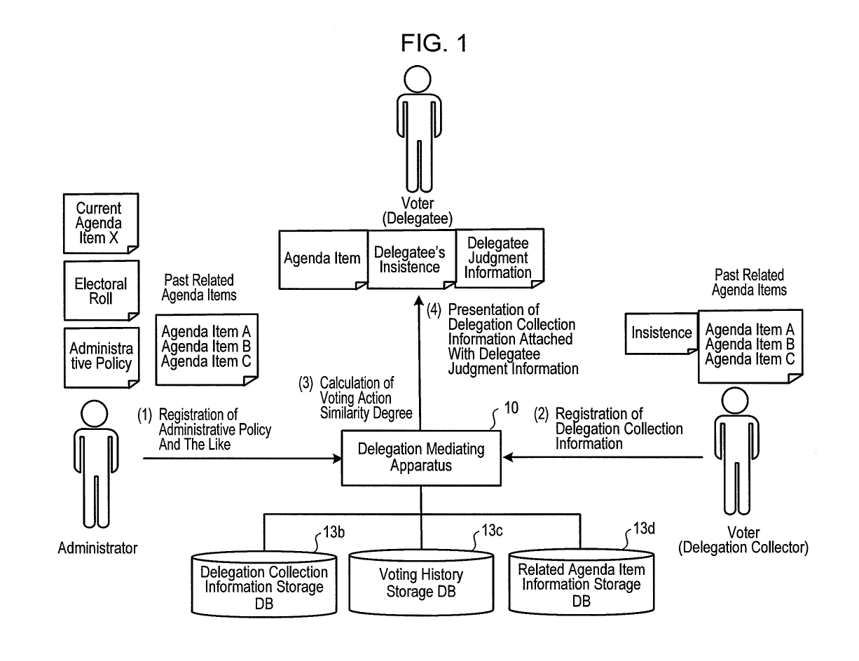

FIG. 1 is a diagram for illustrating the outline and characteristics of the delegation mediating apparatus according to the first embodiment.

A delegation mediating apparatus 10 provides a voter who wants to collect delegations (hereinafter referred to as a delegation collector) with a place where he can actively collect delegations. The delegation mediating apparatus 10 basically performs processing for presenting a delegation collector (hereinafter referred to as a delegatee candidate) who meets requirements of another voter (hereinafter referred to as a delegator) who is looking for a delegatee, from delegation collection information (information made by a delegatee candidate in order to call for delegations from others, including at least insistences of that delegatee candidate on the agenda items for which that delegatee candidate wants to collect votes from others) registered by delegation collectors, to the delegator.

The delegation mediating apparatus 10 provides objective information (delegatee certification information) which can be used for judging the appropriateness of the delegatee candidate in addition to the delegation collection information.

The delegatee certification information is generated on the basis of a voter's past voting history.

In this apparatus, two kinds of delegatee certification information are used.

That is, first delegatee certification information is a degree of voting action similarity between a delegatee candidate and a delegator on the basis of voting histories. This information is for judging the closeness of the opinions of the delegator and the delegatee candidate.

Second delegatee certification information is a table for comparing voting actions among multiple delegatee candidates about past related agenda items. This information is mainly for judging differences in opinion between a delegator and each delegatee candidate or among the multiple delegatee candidates.

As shown in FIG. 1, three databases 13b, 13c and 13d are provided. A delegation collection information storage database 13b stores delegation collection information registered by delegation collectors, each record of which includes at least the information obliged to a delegation collector to input by an administrative policy (e.g., personal information about the delegation collector and the one's insistences on the agenda items for which the one wants to collect votes from others); a voting history storage database 13c stores basic information for generating delegatee certification information, which includes voting histories of all voters on past agenda items; and a related agenda item information storage database 13d stores supplementary information for generating delegatee certification information, which comprises past agenda items related to a current agenda item provided by administrators, delegation collectors, and/or other voters.

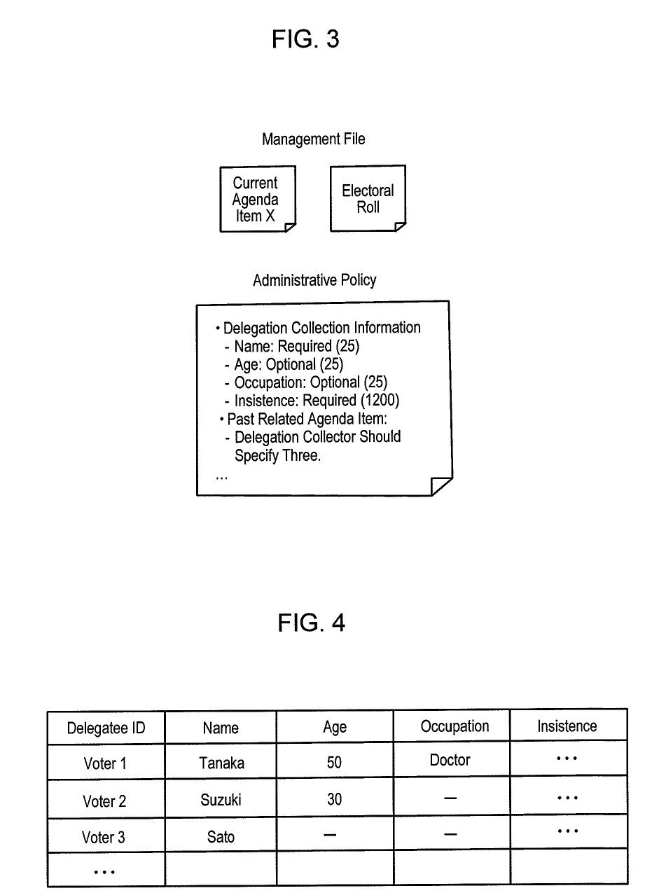

In addition, there is provided a management file (described in detail later with the use of FIG. 3) for controlling various processings of this apparatus, such as an administrative policy and an electoral roll.

The delegation mediating apparatus 10 accepts registration of a current agenda item, past related agenda items, an electoral roll, an administrative policy and the like, from an administrator (see (1) in FIG. 1).

Here, the administrative policy is for setting what should be inputted by each delegation collector as delegation collection information. By utilizing this, the administrator can oblige delegation collectors to disclose personal information (such as name, age and occupation) about the delegation collectors and register past related agenda items.

Next, the delegation mediating apparatus 10 accepts registration of delegation collection information from delegation collectors (see (2) in FIG. 1).

The contents of the delegation collection information depends on the setting of an administrative policy. The contents are mainly personal information about each delegation collector and his insistence on an agenda item.

Here, if registration of past related agenda items is obliged by the administrative policy, the delegation collector picks up past agenda items related to the current agenda item from his voting history and registers them.

After that, when registration of the delegation collection information by the delegation collectors ends, the delegation mediating apparatus 10 waits for requests to refer to the delegation collection information from delegators.

Then, when receiving a request to refer to the delegation collection information, the delegation mediating apparatus 10 calculates the voting action similarity between delegation collectors to be delegatee candidate and the delegator with the use of the past voting histories stored in the voting history storage database 13c (see (3) in FIG. 1).

In the embodiment below, all delegation collectors as a whole are basically treated as delegatee candidates. However, it is also conceivable to treat only such delegation collectors as meet a condition (for example, “a person who lives in the A region”) specified by a delegator as delegatee candidates.

Then, the delegation mediating apparatus 10 preferentially presents a delegatee candidate with a high degree of similarity to the delegator who requested for reference, to the delegator.

Specifically, the delegation mediating apparatus 10 generates delegatee certification information, and presents delegation collection information with the delegatee certification information attached, to the delegator (see (4) in FIG. 1).

Thus, as mentioned above in the description of the main characteristic of the first embodiment, the delegation mediating apparatus 10 can provide objective information (delegatee certification information) to be material for judging the appropriateness of a delegates, to a delegator separately from the delegation collection information created by delegation collectors.

### <Configuration of the Delegation Mediating Apparatus>

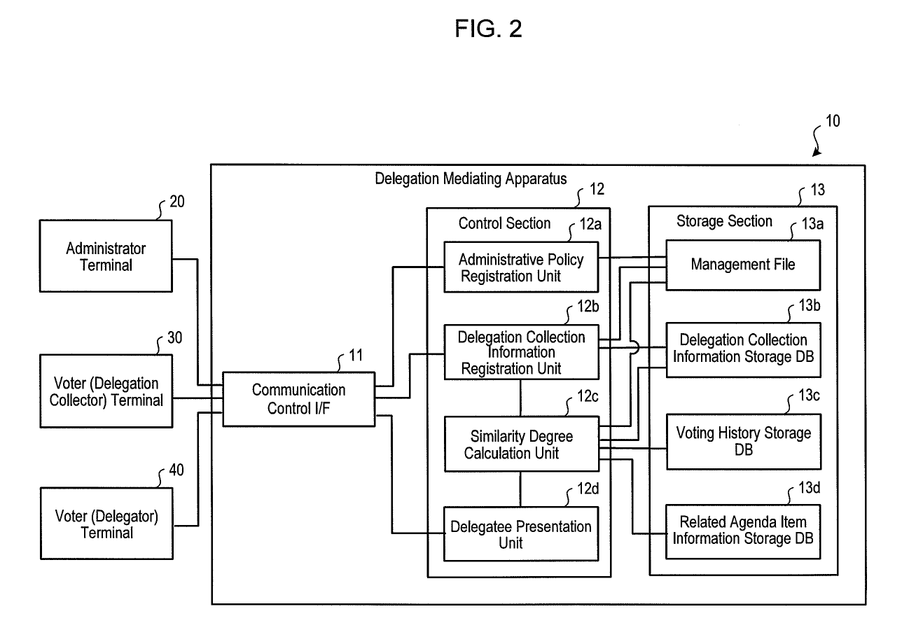

Next, the configuration of the delegation mediating apparatus 10 shown in FIG. 1 will be described with the use of FIGS. 2 to 12.

FIG. 2 is a block diagram showing the configuration of the delegation mediating apparatus 10 according to the first embodiment. FIG. 3 is a diagram showing an example of the management file. FIG. 4 is a diagram showing an example of the delegation collection information storage database.

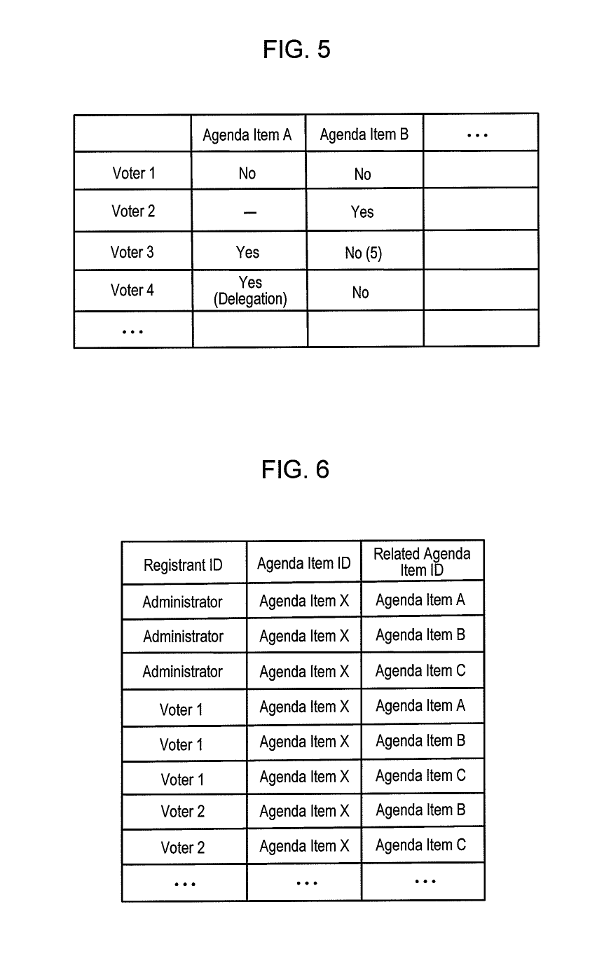

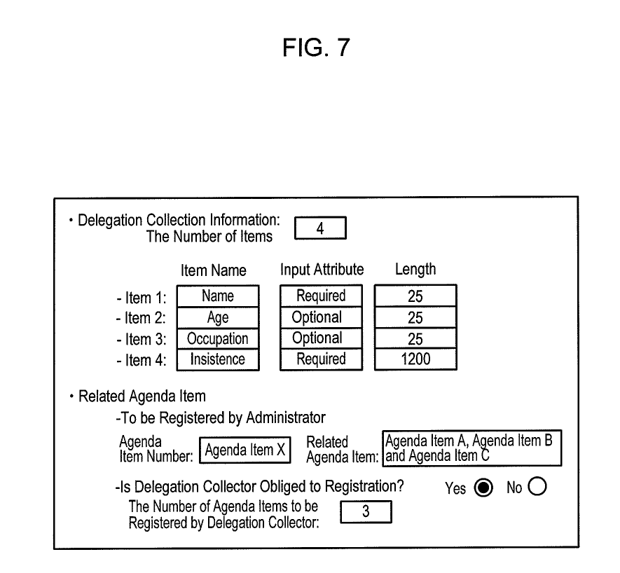

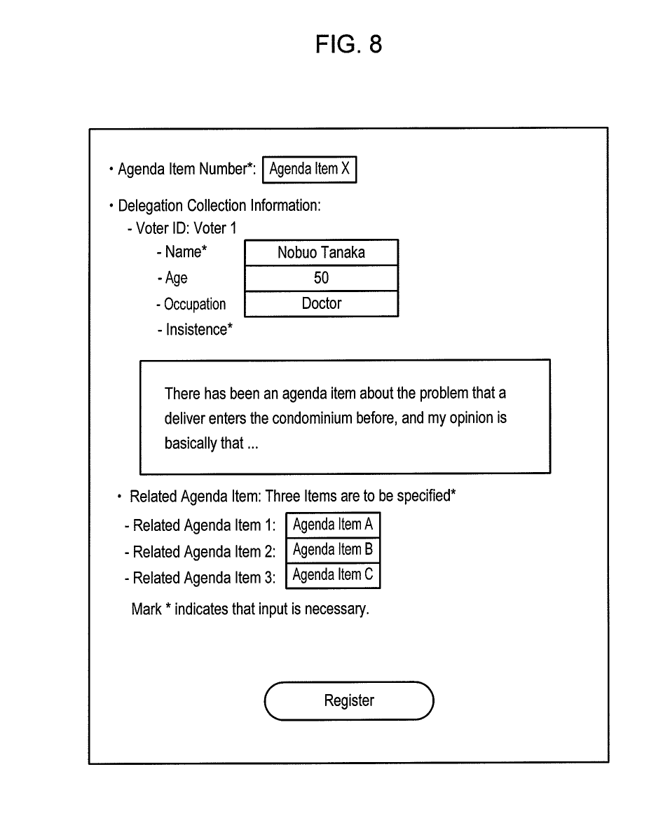

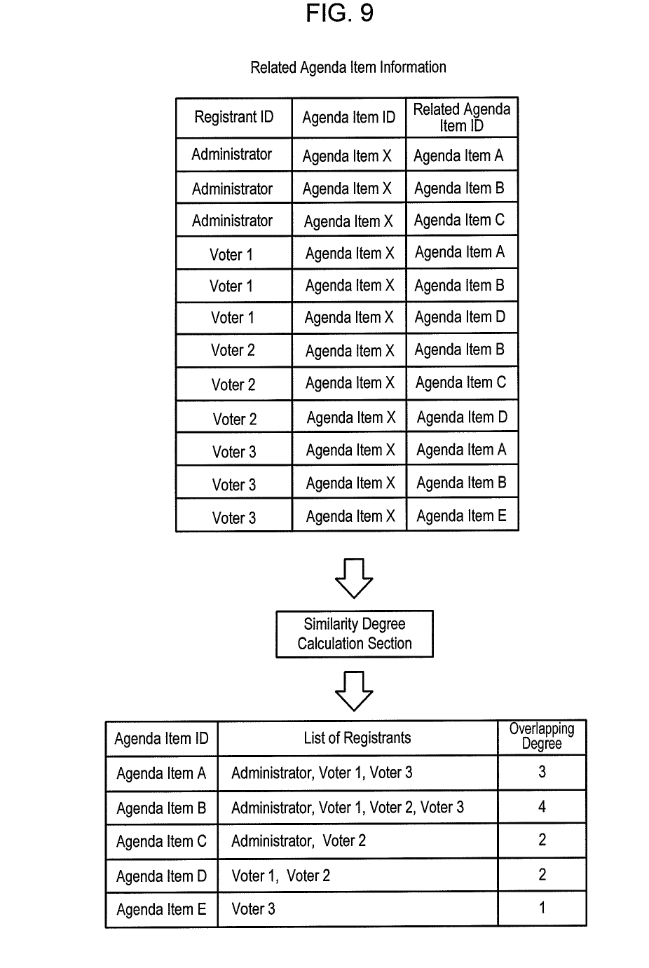

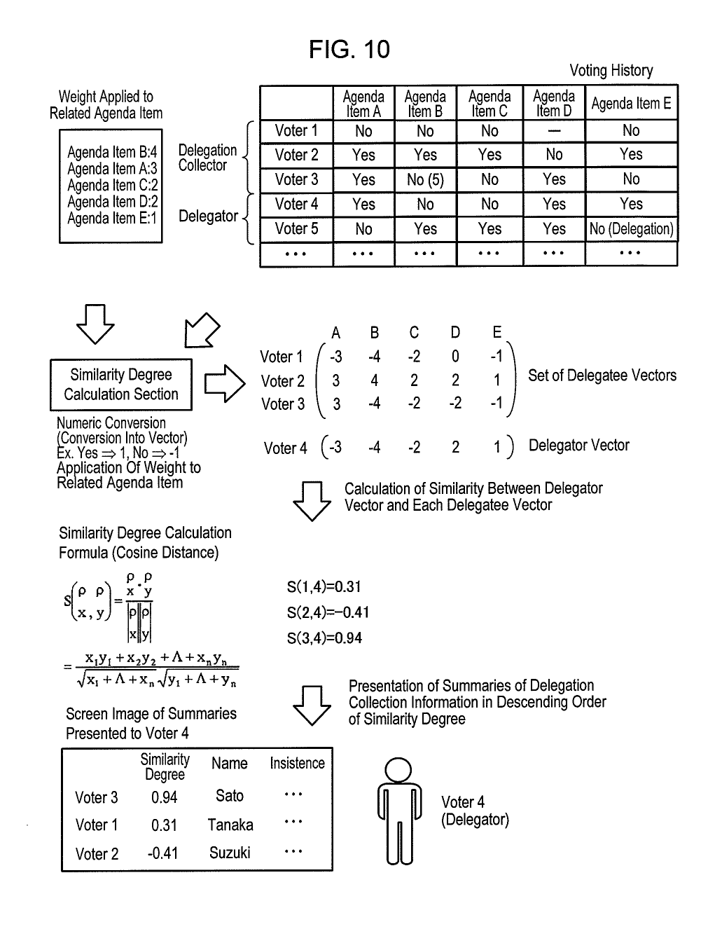

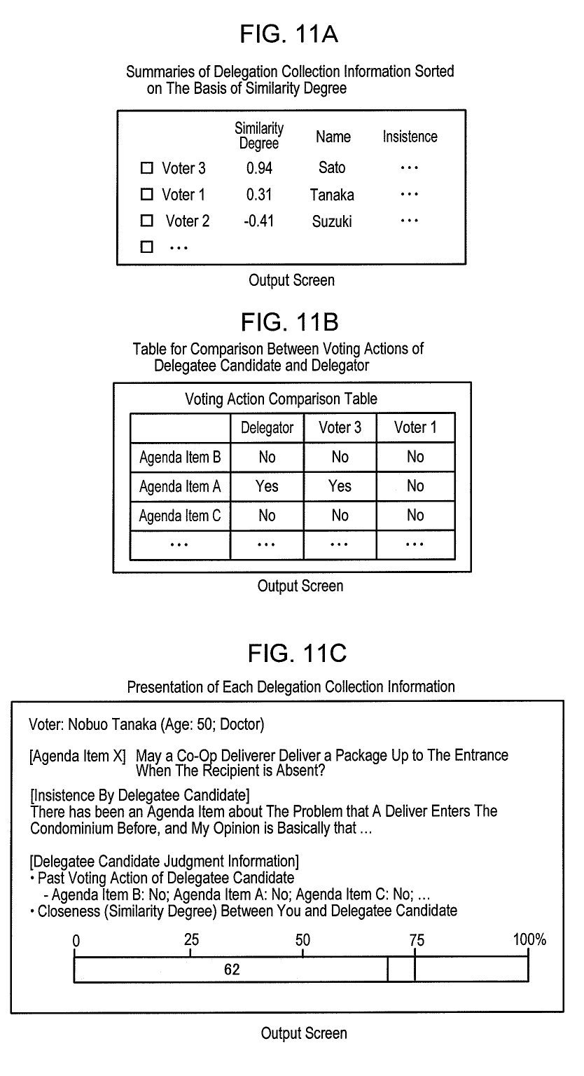

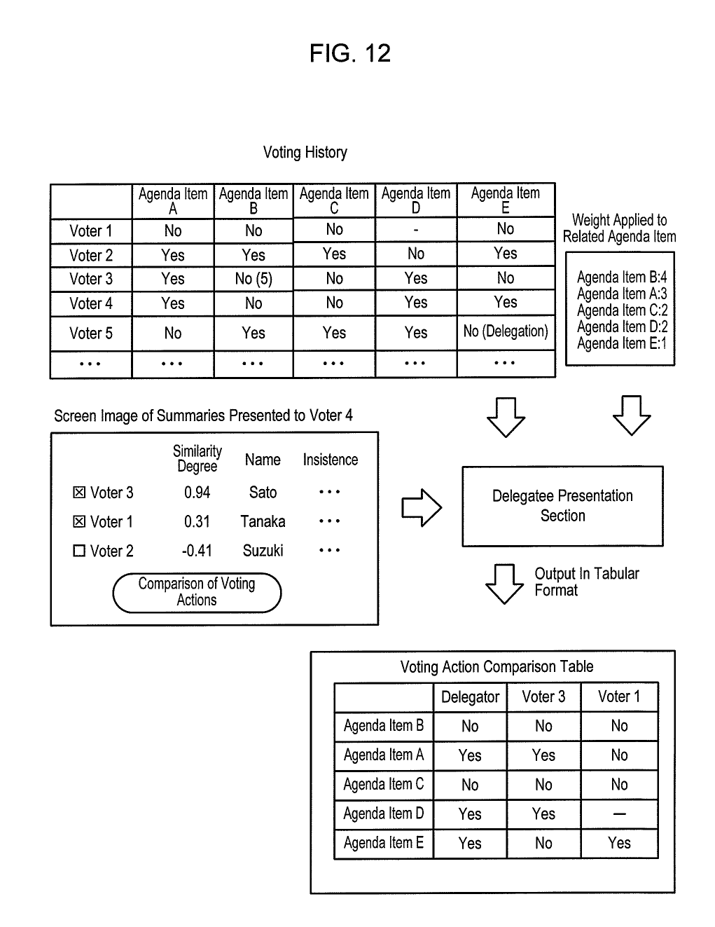

FIG. 5 is a diagram showing an example of the voting history storage database. FIG. 6 is a diagram showing an example of the related agenda item information storage database. FIG. 7 is a diagram showing an example of an administrative policy setting screen. FIG. 8 is a diagram showing an example of a delegation collection information registration screen. FIG. 9 is a diagram showing an example of applying weights to related agenda items. FIG. 10 is a diagram showing an example of calculation of a degree of voting action similarity. FIG. 11 is a diagram showing an example of an output screen displayed when delegation collection information is referred to. FIG. 12 is a diagram showing an example of creation of a voting action comparison table.

As shown in FIG. 2, the delegation mediating apparatus 10 is provided with a communication control I/F 11, a control section 12 and a storage section 13, and it is connected to an administrator terminal 20, one or more voter (delegation collector) terminals 30 and one or more voter (delegator) terminals 40 via a network not shown.

The processing by each of the units will be described below.

The communication control I/F 11 controls communication related to various information exchanged among the administrator terminal 20, the voter (delegation collector) terminals 30 and the voter (delegator) terminals 40.

The storage units in the storage section 13 store data and programs required for various processings by the control units in the control section 12. Especially as distinct features of this technique, the storage section 13 is provided with a management file 13a, the delegation collection information storage database 13b, the voting history storage database 13c and the related agenda item information storage database 13d.

The voting history storage database 13c corresponds to the “voting history storage unit” described in the claims.

The management file 13a stores an administrative policy and the like registered by the administrator.

Specifically, the management file 13a stores the contents of a current agenda item, an electoral roll, an administrative policy and the like as shown in FIG. 3.

Here, the administrative policy is information registered by the administrator, and it includes items to be inputted by a delegation collector as delegation collection information, the input attributes (whether required or not) and the length of the items, the way of selecting a related agenda item, and other control information.

The delegation collection information storage database 13b stores delegation collection information registered by delegation collectors.

Specifically, the delegation collection information storage database 13b stores a delegatee ID which uniquely indicates each delegation collector, his name, his occupation, his insistence and the like, as seen in FIG. 4.

The voting history storage database 13c stores each voter's voting history.

Specifically, as shown in FIG. 5, the voting history storage database 13c stores the contents of past proceedings and the voting histories of all voters, and it stores the contents of each agenda item and the voting action of each voter in a tabular format.

Here, when a certain voter has delegated his vote to another voter in the past, storage is performed with the voting action of the delegatee voter (in the example in FIG. 5, the vote by a voter 4 about an agenda item A, which indicates the result of the vote by a delegatee) reflected thereon.

Similarly, in the case of collecting delegations from other voters and casting votes, the number of the collected delegations is also recorded (in the example in FIG. 5, the vote by a voter 3 about an agenda item B; the numerical value in parentheses indicates the number of collected delegations).

In the case of abstention from voting, it is recorded (in the example of FIG. 5, the vote by a voter 2 in the voting about an agenda item A; the mark “−” indicates that the voter 2 abstained from voting).

The related agenda item information storage database 13d stores information about related agenda items registered by the administrator or delegation collectors.

For example, FIG. 6 shows an example in which the “agenda item A”, “agenda item B” and “agenda item C” are stored as registered agenda items related to an agenda item X registered by the administrator, and delegation collectors are obliged to register the three related agenda items when registering their delegation collection information.

The control section 12 has an internal memory for storing programs specifying various processing procedures and the like and required data, and it executes various processings with the programs and the data. Especially as distinct features of this technique, the control section 12 is provided with an administrative policy registration unit 12a, a delegation collection information registration unit 12b, a similarity degree calculation unit 12c and a delegatee presentation unit 12d.

The similarity degree calculation unit 12c corresponds to the “similarity degree calculation means” described in the claims, and the delegatee presentation unit 12d corresponds to the “delegatee presentation means” described in the claims.

The administrative policy registration unit 12a accepts a current agenda item and past related agenda items, an electoral roll, an administrative policy and the like from the administrator terminal 20 and stores them in the management file 13a.

Now, the setting of an administrative policy by the administrator terminal 20 will be described with the use of FIG. 7.

In FIG. 7, those things surrounded by rectangles indicate input by the administrator.

FIG. 7 shows an example in which four items are specified as delegation collection information items, and the specified items are: name (required; within 25 characters), age (omissible; within 25 characters), occupation (omissible; within 25 characters) and insistence (required; within 1200 characters).

The items and item attributes specified here have an influence on the table schema for the delegation collection information storage database 13b and the delegation collection information registration screen.

In the example in FIG. 7, the “agenda items A, B and C” are set as agenda items related to the agenda item X which have been registered by the administrator. The delegation collectors are obliged to register the three registered agenda items when registering delegation collection information.

The delegation collection information registration unit 12b refers to the setting information of an administrative policy stored in the management file 13a to determine the database schema for the delegation collection information storage database 13b, and creates a table for storing delegation collection information.

The delegation collection information registration unit 12b accepts registrations of delegation collection information from the voter (delegation collector) terminals 30 and stores them in the delegation collection information storage database 13b.

Now, registration of delegation collection information by the voter (delegation collector) terminal 30 will be described with the use of FIG. 8. Things surrounded by rectangles indicate input by the administrator.

FIG. 8 shows an example in which a voter 1, Mr. Nobuo Tanaka, registers delegation collection about the agenda item X. The items attached with “*” are items set as required items in the setting policy.

In the example in FIG. 8, delegation collectors are obliged to register related agenda items (the administrative policy setting example in FIG. 6), and delegation collectors have registered a specified number of related agenda items.

In this case, the related agenda items to be registered by the delegation collectors may be freely selected by each delegation collector from among past agenda items or may be selected by the delegation collectors from a pull-down menu showing multiple past agenda items selected by the administrator in advance.

It is also possible to compare the various information (such as name) inputted by the delegation collectors with an electoral roll stored in the management file to check whether the information is correct, as necessary.

The similarity degree calculation unit 12c calculates the degree of voting action similarity between delegation collectors to be delegatee candidates and a delegator, with the use of past voting histories stored in the voting history storage database 13c.

Specifically, the similarity degree calculation unit 12c applies weights to related agenda items, and, when receiving a request to refer to delegation collection information, from a delegator, it calculates the degree of similarity between the requesting delegator and the delegatee candidates who have registered the delegation collection information.

Now, an example of applying weights to agenda items will be described with the use of FIG. 9.

The weights calculated here are used to automatically select the range of voting history or calculate the degree of voting action similarity. In the example in FIG. 9, it is assumed that related agenda items have been registered by the administrator and the delegation collectors.

The similarity degree calculation unit 12c reads related agenda item information from the related agenda item information storage database 13d and calculates the degree of registration overlapping for each related item by counting the number of persons who have registered an identical item.

The degree of overlapping determined here is set as the weight for each related agenda item. For example, in the example in FIG. 9, the agenda item A is registered by three people (the administrator, the voter 1 and the voter 3), and the agenda item B is registered by four people (the administrator, the voter 1, the voter 2 and the voter 3). Therefore, the weights for the agenda items A and B are 3 and 4, respectively.

If an upper limit is set, it is possible to preferentially select an agenda item with a larger weight with the use of the weights calculated above.

In the example in FIG. 9, if it is assumed that “4” is specified as an upper limit, the four agenda items B, A, C and D with large weights are selected as a use range for generating delegatee certification information.

It is also possible to apply a large weight to the related agenda items registered by the administrator so that the related agenda items selected by the administrator are necessarily selected even when an upper limit is set.

In the above description, an example has been shown in which the weights of related agenda items are determined with the basis of related agenda items registered by an administrator or delegation collectors. However, the weights can also be calculated by using the degree of similarity between the contents (character strings) of an agenda item of interest and each of past agenda items, especially in such a case where no related agenda items are registered.

It is also possible to modify the weights of agenda items by recording the voting date and time of past agenda items and using an increasing function with time (assign a larger weight to a recent agenda item and a smaller weight to an old agenda item).

Furthermore, these multiple weighting methods may be combined and used.

Now, description will be made on an example of calculation of the degree of voting action similarity between a delegatee candidate and a delegator, with the use of FIG. 10.

FIG. 10 shows that the voters 1, 2, 3 collect delegations, and that a voter 4 refers to delegation collection information as a delegator.

First, the similarity degree calculation unit 12c determines the range of voting history to be used for calculation of the similarity degree.

Next, the similarity degree calculation unit 12c reads the voting actions of delegation collectors to be delegatee candidates and the delegator from the voting history storage database 13c, and performs numeric conversion (conversion into vector expression) of the voting actions of the delegatee candidates and the delegator in accordance with a certain predetermined rule.

Next, the similarity degree calculation unit 12c calculates the cosine distance to each of the delegatee vectors (the voters 1, 2 and 3), with the delegator vector (the voter 4 in FIG. 10) as a base.

After that, the summaries of delegation collection information (such as the name and the leading portion of insistence) are presented to the delegator by the delegatee presentation unit 12d in descending order of the degree of similarity.

The example in FIG. 10 shows a vector obtained by performing numeric conversion of each voting action, on the assumption that YES (approval) is denoted by 1, NO (opposition) by −1, and − (abstention) by 0, and multiplying the numeric value by the weight of each related agenda item determined in FIG. 9.

Here, the degree of similarity between the voter 1 and the voter 4 is calculated as “S(1, 4)=0.31”; the degree of similarity between the voter 2 and the voter 4 is calculated as “S(2, 4)=−0.41”; and the degree of similarity between the voter 3 and the voter 4 is calculated as “S(3, 4)=0.94”. Therefore, when seen from the voter 4, the descending order of the similarity degree is: the voters 3, the voter 1 and the voter 2.

Consequently, the summaries of the delegation collection information are presented to the voter 4 by the delegatee presentation unit 12d (described later), in the order of the voters 3, 1 and 2.

If the delegator (vector) who refers to the delegation collection information differs, the cosine distance to each delegatee (vector) changes, and the similarity degree also changes.

For example, in the example in FIG. 10, as for a voter 5 (delegator), the degree of similarity to the voter 1 is “S(1, 5)=−0.31”; the degree of similarity to the voter 2 is “S(2, 5)=0.18”; and the degree of similarity to the voter 3 is “S(3, 5)=−0.71”. Therefore, the summaries of the delegation collection information are presented by the delegatee presentation unit 12d, in the order of the voters 2, 1 and 3.

In the above description, an example has been shown in which the similarity degree is calculated on the basis of the cosine distance between the vectors constructed by converting the voting actions of voters into numeric values. However, it is possible to simply calculate the similarity degree with the number of those related agenda items that voting actions of voters agree with each other in place of using vector expression.

The delegatee presentation unit 12d presents a delegatee candidate with a high degree of similarity to a delegator, on the voter (delegator) terminal 40.

For example, as illustrated in FIG. 11(a), the delegatee presentation unit 12d presents the summaries (the name and a part of insistence) of delegation collection information which have been sorted on the basis of the similarity degree in descending order of the similarity degree, from the top.

Furthermore, as illustrated in FIG. 11(b), the delegatee presentation unit 12d presents a table for comparison between the voting actions of multiple delegatee candidates and a delegator, in which a voting action by a delegatee candidate different from that of the delegator is outputted and highlighted.

Furthermore, as illustrated in FIG. 11(c), the delegatee presentation unit 12d presents each delegation collection information, and, in addition to personal information about a delegatee candidate and his insistence on an agenda item, outputs the past voting actions of the delegatee candidate and the closeness of his opinions with those of the delegator as delegatee certification information at the same time.

Now, description will be made of an example of creating the table for comparison between the voting actions of multiple delegatee candidates and a delegator, which is the second delegatee certification information, with the use of FIG. 12.

First, the voter (delegator) terminal 40 is caused to select delegatee candidates to be compared.

FIG. 12 shows an example in which selection buttons and a creation button for creating a comparison table is given to a delegation collection information summary output screen. Here, the voter 3 and the voter 1 are selected by the voter 4.

Next, the delegatee presentation unit 12d determines the range of voting history to be outputted and reads the voting histories of the selected delegatee candidate and the delegator.

After that, the delegatee presentation unit 12d outputs the voting actions of the delegatee candidates and the delegator in a tabular format in the order of the weights for the related agenda items illustrated in FIG. 9.

In the output example in FIG. 12, voting actions different from the voting action of the delegator are displayed and highlighted.

Thereby, it is possible to easily confirm which agenda item the voting action of each delegatee candidate is different from the voting action of the delegator.

Furthermore, it is possible to confirm about which agenda item each delegatee candidate collected a lot of delegations (the comparison table: voting of the voter 3 about the agenda item B), about which agenda item each delegatee candidate abstained from voting (the comparison table: voting of the voter 1 about an agenda item D), and the like.

FIG. 12 shows an example of outputting a table for comparison of voting actions of delegatee candidates about the same related agenda items as used in calculation of the degree of voting action similarity. However, the agenda items to be outputted may be selected by a delegator.

### <Processing by the Delegation Mediating Apparatus>

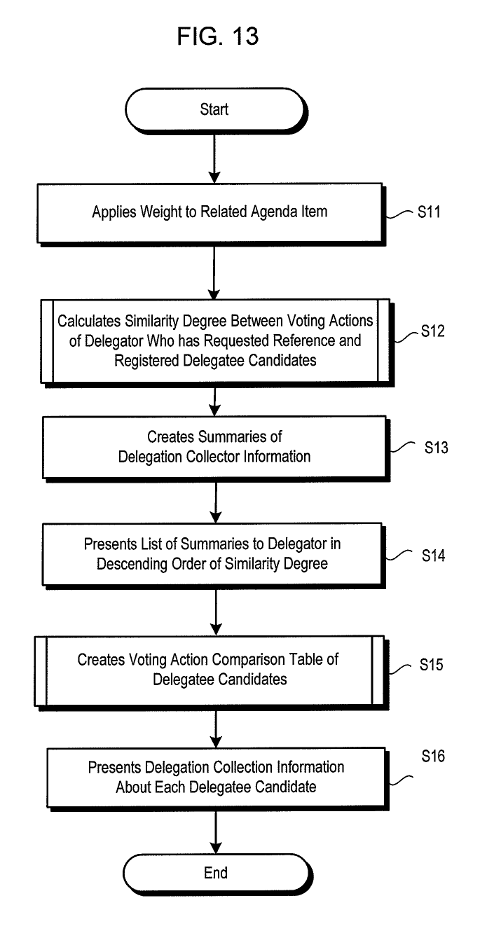

Next, the processing by the delegation mediating apparatus 10 according to the first embodiment will be described with the use of FIGS. 13 to 16.

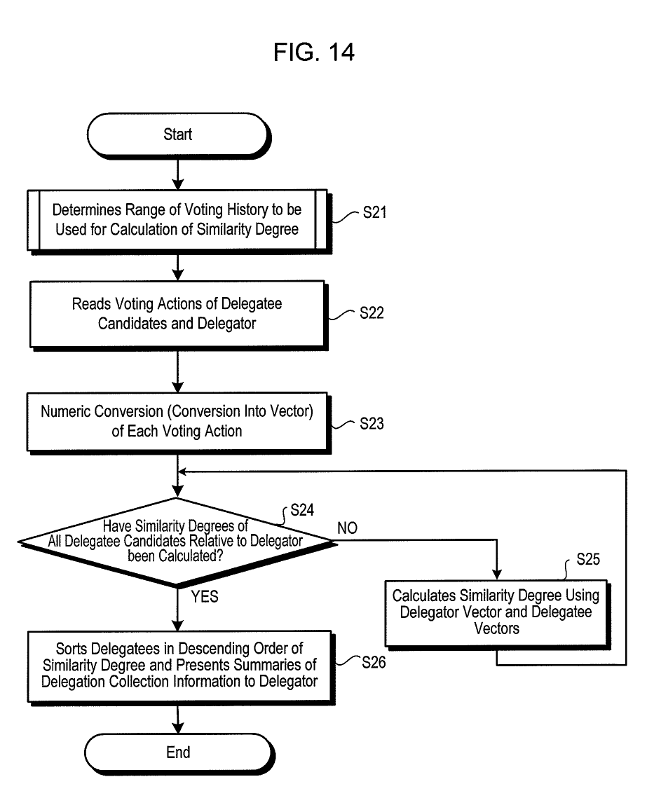

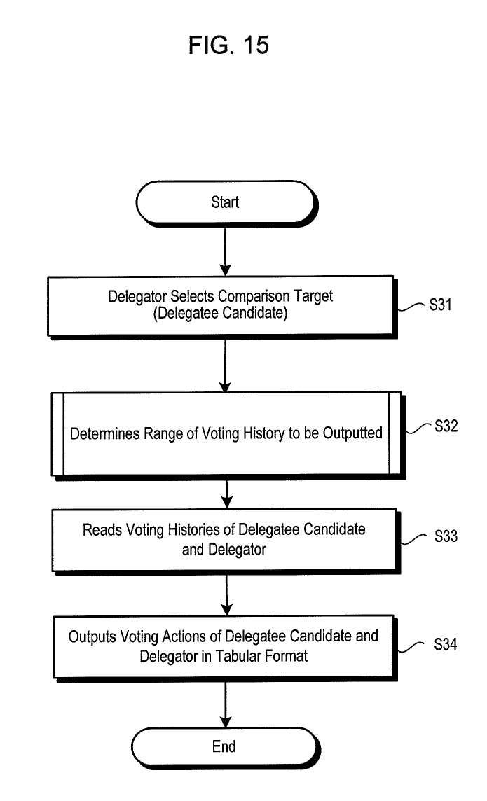

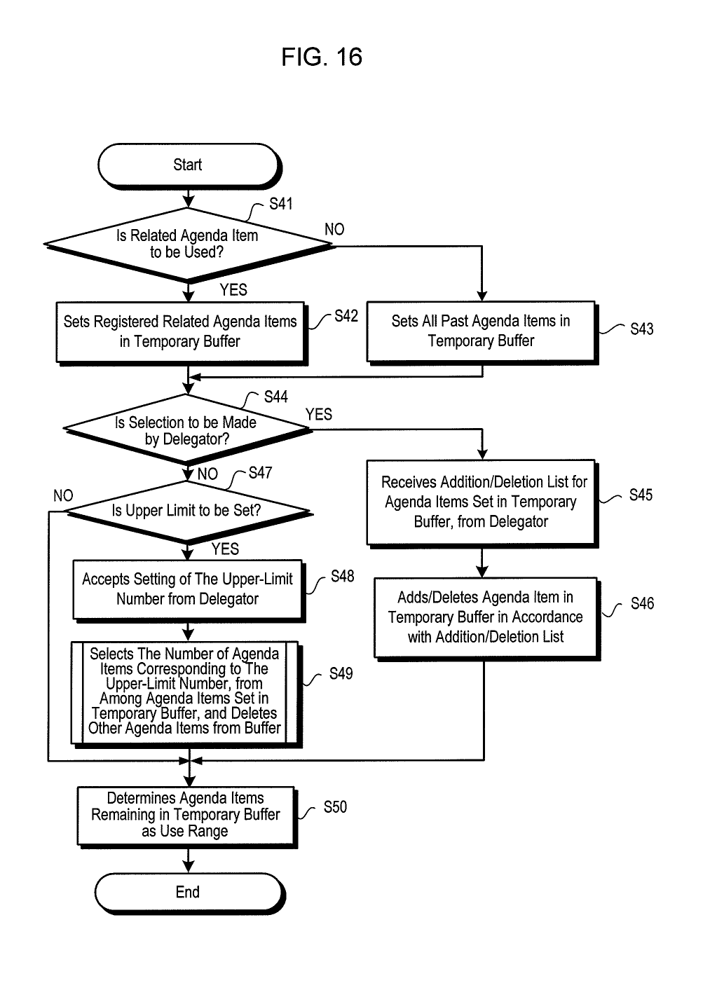

FIG. 13 is a flowchart showing the processing operation of the delegation mediating apparatus according to the first embodiment. FIG. 14 is a flowchart showing a voting action similarity degree calculation procedure. FIG. 15 is a flowchart showing a voting action comparison table creation procedure. FIG. 16 is a flowchart showing a procedure for determining the range of a voting history to be used for generation of delegatee certification information.

As shown in FIG. 13, the delegation mediating apparatus 10 applies weights to related agenda items (step S11).

Next, when receiving a request to refer to delegation collection information from a delegator, the delegation mediating apparatus 10 calculates the degree of similarity between the requesting delegator and delegatee candidates who registered delegation collection information in accordance with the similarity degree calculation procedure to be described in detail later with the use of FIG. 14 (step S12).

When finishing calculation of the degree of similarity to all the delegatee candidates, the delegation mediating apparatus 10 creates a summary of delegation collection information about each delegatee candidate (such as the name and the first half of insistence) (step S13), sorts the summaries in descending order of the similarity degree, and presents them to the delegator (step S14).

Next, the delegation mediating apparatus 10 causes the delegator to select delegatee candidates to be compared, creates a voting action comparison table in accordance with the comparison table creation procedure to be described in detail later with the use of FIG. 15, about the selected delegatee candidates, and presents the voting action comparison table to the delegator (step S15).

After that, the delegation mediating apparatus 10 presents each delegation collection information to the delegator in accordance with the delegator's request (step S16).

Then, the delegation mediating apparatus 10 returns to the output screen of step S14 and repeats steps S15 and S16 until the delegator can find a delegatee to whom he wants to delegate his vote.

Next, the voting action similarity degree calculation procedure will be described with the use of FIG. 14.

As shown in the figure, the delegation mediating apparatus 10 determines the range of voting history to be used for calculation of the similarity degree in accordance with the voting history range determination procedure to be described in detail later with the use of FIG. 16 (step S21).

Next, the delegation mediating apparatus 10 reads the voting actions of the delegatee candidates and the delegator from the voting history storage database 13c (step S22) and performs numeric conversion (conversion into vector expression) of the voting actions of the delegatee candidates and the delegator in accordance with a certain predetermined rule (see FIG. 12) (step S23).

Then, the delegation mediating apparatus 10 judges whether the degree of similarity for all the delegatee candidates to the delegator has been calculated (step S24). If the degree of similarity has not been calculated for all the delegatee candidates (step S24: NO), the delegation mediating apparatus 10 calculates the cosine distance to each of the delegatee vectors (the voters 1, 2 and 3) with the delegator vector as a base (step S25) and repeats the processing until the degree of similarity is calculated for all the delegatee candidates.

If the degree of similarity has been calculated for all the delegatee candidates (step S24: YES), the delegation mediating apparatus 10 presents the summaries of delegation collection information (such as the name and the leading portion of insistence) to the delegator in ascending order of the similarity degree (step S26).

Next, the voting action comparison table creation procedure will be described with the use of FIG. 15.

The delegation mediating apparatus 10 creates a comparison table to be used for comparing voting action differences among multiple delegatee candidates in accordance with the procedure shown in the figure.

First, the delegation mediating apparatus 10 waits for a delegator to select the delegatee candidates to be compared (step S31).

Next, the delegation mediating apparatus 10 determines a range of voting history to be outputted with the voting history range determination procedure shown in FIG. 16 (described in detail later) (step S32).

Then, the delegation mediating apparatus 10 reads the voting histories, within the range determined at S32, of the delegatee candidates selected at S31 and the delegator (step S33) and outputs the voting histories in a tabular format (step S34).

Next, description will be made of the procedure for determining the range of voting history to be used for generation of delegatee certification information, with the use of FIG. 16.

As shown in the figure, the delegation mediating apparatus 10 determines whether or not to use related agenda items registered in the apparatus (step S41).

As a result, if the related agenda items are to be used (step S41: YES), then the delegation mediating apparatus 10 sets the related agenda items registered by the administrator or delegation collectors in a temporary buffer (step S42).

If the related agenda items are not to be used (step S41: NO), then the delegation mediating apparatus 10 sets all the past agenda items in the temporary buffer (step S43).

Next, the delegation mediating apparatus 10 determines whether or not to cause the delegator to select the range of use (agenda items) (step S44).

In the case of causing the delegator to select the range of use (step S44: YES), the delegation mediating apparatus 10 receives an agenda item addition/deletion list from the delegator (step S45), and adds or deletes agenda items in the temporary buffer in accordance with the list (step S46).

In the case of not causing the delegator to select the range of use (step S44: NO), the delegation mediating apparatus 10 determines whether or not to set an upper limit (step S47). If an upper limit is to be set (step S47: YES), the delegation mediating apparatus 10 deletes agenda items beyond the upper limit from the temporary buffer (step S49).

Finally, the delegation mediating apparatus 10 determines the agenda items remaining in the temporary buffer as the range of use (step S50).

In the processing in FIG. 16, the determinations made at S41, S44 and S47 may be made and set in advance as an administrative policy by the administrator or may be made by causing the delegator to make a selection when the delegator refers to delegation collection information.

### Advantages of the First Embodiment

As described above, the delegation mediating apparatus 10 stores each voter's past voting history in the voting history storage database 13c, calculates the degree of voting action similarity between delegation collectors to be delegatee candidates and a delegator with the use of past voting histories stored in the voting history storage database 13c, and presents a delegatee candidate with a high degree of similarity to the delegator, to the delegator. Therefore, the delegator can easily find such a delegatee that the past voting actions are similar to those of the delegator, that is, a delegatee with opinions and a sense of value close to those of the delegator.

Thus, it is possible reduce the delegator's burden of looking for a delegatee.

Furthermore, according to the first embodiment, past agenda items related to a current agenda item inputted by an administrator are collected from delegation collectors and the administrator, and difference in the voting action about the collected related agenda items between delegatee candidates and a delegator is presented to the delegator. Therefore, it is possible to present the voting histories of the delegatee candidates and the delegator about the related agenda items collected from the administrator and the delegation collectors, to the delegator in a form facilitating comparison. Consequently, it is possible for the delegator to easily guess differences of opinion and values between the delegatee candidates and himself. For example, even if there are multiple delegatee candidates having similar insistences, it is possible to preferentially select a delegatee who has the same opinion about a point the delegator applies more importance to.

Furthermore, according to the first embodiment, since difference in the voting action about collected related agenda items among multiple delegatee candidates is presented to a delegator, the delegator can easily refer to the characteristics of the voting actions of the delegatee candidates, which cannot be judged from the insistence or the related agenda items shown by a certain one delegatee candidate. As a result, the delegator can select a delegatee who can be expected to exercise the delegator's vote for the direction the delegator desires, with a stronger confidence. For example, even in the case where a part of delegatee candidates attempt to conceal their voting actions about a past agenda item, which are inconvenient to them for delegation collection, a different delegation collector register that related agenda item, the delegator could refer to the voting actions of the delegatee candidates about the related agenda item and select a suitable delegatee.

Furthermore, according to the first embodiment, on the basis of related agenda items collected in accordance with the related agenda item collection procedure, the degree of voting activity similarity between a delegatee candidate and a delegator about the related agenda items is calculated. Thus, not the degree of voting action similarity between a delegatee candidate and a delegator for all the past agenda items but the degree of voting action similarity between a delegatee candidate and a delegator about related past agenda items is calculated. Therefore, it is possible to calculate a value of a similarity degree with higher reliability.

### Second Embodiment

An embodiment has been described. However, in addition to the embodiment described above, the present invention may be practiced in various different embodiments.

Therefore, another embodiment will be described below as a second embodiment.

(1) System Configuration and the Like

The components of the apparatus in the figures are shown from a viewpoint of a functional concept, and the apparatus is not necessarily required to be configured as shown in the figures.

That is, the concrete forms of distribution and integration for the apparatus are not limited to those shown in the figures, and it is possible to configure the apparatus by functionally or physically distributing/integrating a part or all of the components in any unit depending on various loads and use states.

For example, the administrative policy registration unit 12a and the delegation collection information registration unit 12b may be integrated.

Furthermore, as for each processing function performed by the apparatus, all or any part of it can be realized by a CPU and a program analyzed and executed by the CPU or realized as hardware by a wired logic.

(2) Program

The various processings described in the above embodiment can be realized by executing a program prepared in advance on a computer. Such program is stored in a computer-readable storage medium such as a hard disk, a flexible disk, compact disc ROM (CD-ROM), magneto-optical (MO) disk, and digital versatile disk (DVD), and executed by a computer. The program may be transmission medium distributable through a network such as Internet.

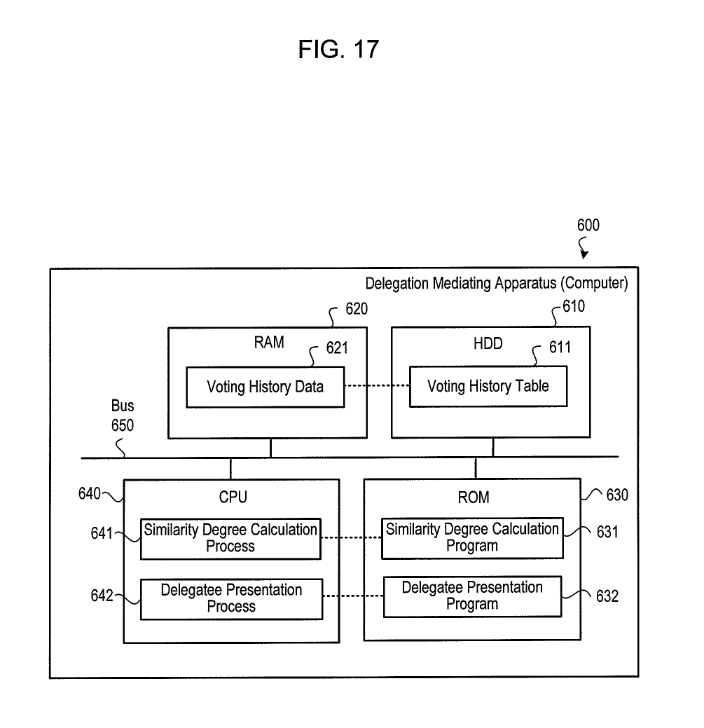

An example of the computer for executing a program having functions similar to those in the above embodiment will be described below with the use of FIG. 17.

FIG. 17 is a diagram showing a computer which executes a delegation mediating program.

As shown in the figure, a computer 600 as a delegation mediating apparatus is configured by connecting an HDD 610, a RAM 620, a ROM 630 and a CPU 640 via a bus 650.

In the ROM 630, the delegation mediating program which shows functions similar to those in the above embodiment, that is, a similarity degree calculation program 631 and a delegatee presentation program 632 are stored in advance as shown in FIG. 17.

The programs 631 and 632 may be integrated or distributed as appropriate similarly to the components of the delegation mediating apparatus shown in FIG. 2.

By the CPU 640 reading these programs 631 and 632 from the ROM 630 and executing them, the programs 631 and function as a similarity degree calculation process and a delegatee presentation process 642, respectively, as shown in FIG. 17.

The processes 641 and 642 correspond to the similarity degree calculation unit 12c and the delegatee presentation unit 12d shown in FIG. 2, respectively.

In the HDD 610, there is provided a voting history table 611 as shown in FIG. 17.

The voting history table 611 corresponds to the voting history storage database 13c shown in FIG. 2.

The CPU 640 registers data with the voting history table 611. The CPU 640 also reads voting history data 621 from the voting history table 611, stores it in the RAM 620, and executes processing on the basis of the voting history data 621 stored in the RAM 620.

What is claimed is:

1. A computer-readable recording medium in which a delegation mediating program is recorded, the program causing a computer to execute a delegation mediating method for presenting a voter who wants to collect delegations to another voter who is looking for a delegatee, in a decision to be made by voting by multiple voters, the program comprising:
a voting history storage procedure for storing each voter's past voting history in a voting history storage unit;
a similarity degree calculation procedure for calculating a degree of voting action similarity between the voter who wants to collect delegations and other voter who is looking for a delegatee, with the use of the past voting history stored in the voting history storage unit; and
a delegatee presentation procedure for presenting the voter who wants to collect delegations if the degree of similarity to the other voter who is looking for a delegatee is high, to the other voter who is looking for a delegatee.

2. The computer-readable recording medium according to claim 1, wherein
the delegation mediating program according to claim 1 further causes the computer to execute a related agenda item collection procedure for collecting past agenda items related to a current agenda item inputted by an administrator, from the voter who wants to collect delegations and the administrator; and
the delegatee presentation procedure presents voting action difference between the voter who wants to collect delegations and the other voter who is looking for a delegatee, about the related agenda items collected by the related agenda item collection procedure, to the other voter who is looking for a delegatee.

3. The computer-readable recording medium according to claim 1, wherein
the delegation mediating program further causes the computer to execute a related agenda item collection procedure for collecting past agenda items related to a current agenda item inputted by an administrator, from the voter who wants to collect delegations and the administrator; and
the delegatee presentation procedure presents voting action difference among multiple voters who want to collect delegations, about the related agenda items collected by the related agenda item collection procedure, to the other voter who is looking for a delegatee.

4. The computer-readable recording medium according to claim 1, wherein
the delegation mediating program further causes the computer to execute a related agenda item collection procedure for collecting past agenda items related to a current agenda item inputted by an administrator, from the voter who wants to collect delegations and the administrator; and
the similarity degree calculation procedure calculates a voting action similarity degree between the voter who wants to collect delegations and the other voter who is looking for a delegatee, about the related agenda items collected by the related agenda item collection procedure, to the other voter who is looking for a delegatee.

5. The computer-readable recording medium according to claim 2, wherein
the delegation mediating program further causes the computer to execute an administrative policy acceptance procedure for accepting an administrative policy which makes registration of the related agenda items compulsory; and
if the administrative policy is accepted by the administrative policy acceptance procedure, the delegatee presentation procedure presents only a voter who has registered the related agenda items to the other voter who is looking for a delegatee.

6. The computer-readable recording medium according to claim 3, wherein
the delegation mediating program further causes the computer to execute an administrative policy acceptance procedure for accepting an administrative policy which makes registration of the related agenda items compulsory; and
if the administrative policy is accepted by the administrative policy acceptance procedure, the delegatee presentation procedure presents only a voter who has registered the related agenda items to the other voter who is looking for a delegatee.

7. The computer-readable recording medium according to claim 4, wherein
the delegation mediating program further causes the computer to execute an administrative policy acceptance procedure for accepting an administrative policy which makes registration of the related agenda items compulsory; and
if the administrative policy is accepted by the administrative policy acceptance procedure, the delegatee presentation procedure presents only a voter who has registered the related agenda items to the other voter who is looking for a delegatee.

8. A delegation mediating apparatus which presents a voter who wants to collect delegations to another voter who is looking for a delegatee, in a decision to be made by voting by multiple voters, the apparatus comprising:
voting history storage means for storing each voter's past voting history in a voting history storage unit;
similarity degree calculation means for calculating a degree of voting action similarity between the voter who wants to collect delegations and the other voter who is looking for a delegatee, with the use of the past voting history stored in the voting history storage unit; and
delegatee presentation means for presenting the voter who wants to collect delegations if the degree of similarity to the other voter who is looking for a delegatee is high, to the other voter who is looking for a delegatee.

9. A delegation mediating method for presenting a voter who wants to collect delegations to another voter who is looking for a delegatee, in a decision to be made by voting by multiple voters, the method comprising:
a voting history storage step of storing each voter's past voting history in a voting history storage unit;
a similarity degree calculation step of calculating a degree of voting action similarity between the voter who wants to collect delegations and the other voter who is looking for a delegatee, with the use of the past voting history stored in the voting history storage unit; and
a delegatee presentation step of presenting a voter who wants to collect delegations if the degree of similarity to the other voter who is looking for a delegatee is high, to the other voter who is looking for a delegatee.
